(19) United States
(12) Patent Application Publication
(10) Pub. No.: US 2014/0379254 A1
(43) Pub. Date: Dec. 25, 2014

(54) POSITIONING SYSTEM AND METHOD FOR USE IN A VEHICLE NAVIGATION SYSTEM

(71) Applicant: TomTom Global Content B.V., Eindhoven (NL)

(72) Inventors: Krzysztof Miksa, Lodz (PL); Krzysztof Smiechowicz, Lodz (PL); Hubert Nowak, Piotrkow Trybunalski (PL)

(21) Appl. No.: 14/483,238

(22) Filed: Sep. 11, 2014

Related U.S. Application Data
(63) Continuation-in-part of application No. 13/392,552, filed on May 2, 2012, now Pat. No. 8,868,335.
(60) Provisional application No. 61/236,547, filed on Aug. 25, 2009.

(51) Int. Cl. G01C 21/30; G01S 5/16; G01S 17/02

(52) U.S. Cl. CPC G01C 21/30; G01S 17/023; G01S 5/16
USPC 701/450; 701/409

(57) ABSTRACT

A positioning method for use in a vehicle navigation or mapping system is disclosed, and a system implementing such a method. The method comprises obtaining one or more sets of sensor measurement data from at least one sensor located on or in a vehicle, each set of sensor measurement being indicative of the distance of objects in an environment around the vehicle from the sensor, and each set of sensor measurement data comprising data obtained from a range of positions in a time or distance window along the direction of travel of the vehicle. A correlation procedure is performed correlating the one or more sets of sensor measurement data with stored reference sensor measurement data, and a relative position of the vehicle against stored location data associated with the stored reference sensor measurement data is determined in dependence on the correlation procedure.

### CROSS REFERENCE TO RELATED APPLICATIONS

This application is a continuation-in-part of U.S. Utility patent application Ser. No. 13/392,552, which is the national stage of International Patent Application No. PCT/EP2010/058103 filed Jun. 9, 2010, and which claims the benefit of U.S. Provisional Patent Application No. 61/236,547 filed Aug. 25, 2009. The entire contents of all these applications is incorporated herein by reference.

### FIELD OF THE INVENTION

The present invention relates generally to digital maps, geographical positioning systems and methods, and/or navigation systems and methods, for example to a system and method for vehicle navigation or mapping.

### BACKGROUND TO THE INVENTION

Navigation systems, electronic maps (also referred to herein as digital maps), and geographical positioning devices have been increasingly used in vehicles to assist the driver with various navigation functions, such as: determining the overall position and orientation of the vehicle; finding destinations and addresses; calculating optimal routes (perhaps with the assistance of real time traffic information); and providing real-time driving guidance, including access to business listings or yellow pages. Typically the navigation system portrays a network of streets as a series of line segments, including a centerline running approximately along the centre of each roadway. The moving vehicle can then be generally located on the map close to or co-located with regard to that centerline.

Some early vehicle navigation systems relied primarily on relative-position determination sensors, together with a “dead-reckoning” feature, to estimate the current location and heading of the vehicle. This technique is prone to accumulating small amounts of positional error, which can be partially corrected with “map matching” algorithms. The map matching algorithm compares the dead-reckoned position calculated by the vehicle's computer with a digital map of street centerlines, to find the most appropriate point on the street network of the map, if such a point can indeed be found. The system then updates the vehicle's dead-reckoned position to match the presumably more accurate “updated position” on the map.

With the introduction of reasonably-priced Geographical Positioning System (GPS) satellite receiver hardware, a GPS receiver or GPS unit can be added to the navigation system to receive a satellite signal and to use that signal to directly compute the absolute position of the vehicle. However, map matching is still typically used to eliminate errors within the GPS system and within the map, and to more accurately show the driver where he/she is on (or relative to) that map. Even though on a global or macro-scale, satellite technology is extremely accurate; on a local or micro-scale small positional errors still do exist. This is primarily because the GPS receiver can experience an intermittent or poor signal reception or signal multipath, and also because both the centerline representation of the streets and the actual position of the GPS system may only be accurate to within several meters. Higher performing systems use a combination of dead-reckoning (DR)/inertial navigation systems (INS) and GPS to reduce position determination errors, but even with this combination errors can still occur at levels of several meters or more. Inertial sensors can provide a benefit over moderate distances, but over larger distances even systems with inertial sensors accumulate error.

While vehicle navigation devices have gradually improved over time, becoming more accurate, feature-rich, cheaper, and popular; they still fall behind the increasing demands of the automobile industry. In particular, it is expected that future vehicle navigation applications will require higher positional accuracy, and even more detailed, accurate, and feature-rich maps. Possible enhanced applications are likely to include: Adding more precise navigation guidance features to vehicles, that can be supported by improved mapping capabilities, and provide better usability and convenience for the driver; and Adding various safety applications, such as collision avoidance, which may, in turn, depend on having accurate knowledge of the position and heading of the vehicle relative to other nearby moving and stationary objects, including other vehicles. Within this context, the accuracy within the current generation of consumer navigation systems, on the order of 5 to 10 meters, was thought to be inadequate. It was believed that systems many times more accurate were needed. In order to meet these future needs, the automobile industry sought ways to improve both the accuracy of digital maps and the accuracy of on-board position determination (e.g. GPS, etc.) sensors.

At the same time, the digital mapping industry, represented by companies such as Tele Atlas, is putting greater amounts of information into its digital maps. This increased information is being combined with much higher accuracy so as to better support advanced future applications. Examples of the features now included in digital maps include: the accurate representation of the number of lanes within a particular street or road; the positions of those lanes and barriers; the identification and location of objects such as street signs and buildings footprints; and the inclusion of objects within a rich three-dimensional (3D) representation that portrays actual building facades and other features.

Current navigation systems have sufficient accuracy and map detail to allow the onboard position determination to match the vehicle's position to the appropriate street centerline, and thereby show the vehicle on the proper place in relation to a centerline map. From there the system can help the driver with orientation, routing and guidance functions. However, this level of precision is insufficient both in detail and in accuracy to tell the driver what driving lane he/she may be in (and thereby give more detailed driving guidance), or to warn the driver that he/she may be in danger of a collision. In fact, in today's mapping systems the majority of non-highway roads are depicted on the map with a single centerline which is used for vehicles travelling in both directions. Using contemporary map matching techniques, the vehicles appear to be travelling along the same line, and thus if viewed in relation to each other would always appear to be in danger of collision. Alternatively, for those digital maps in which roads are represented on the map by a centre line in each direction, the cars travelling in each direction would match to the appropriately oriented element of that road segment pair, and the cars, if viewed in relation to each other, would never appear to be in a position to collide, even if in reality the situation was quite different. United States Patent Publication No. 2008/0243378 proposes the addition of attribute data on map database objects that include relative position coordinates having high relative accuracy with respect to objects within its vicinity and the addition of sensor systems in the vehicle that can detect objects within its vicinity. Embodiments of that invention were designed to meet the perceived advanced needs which the automobile industry is striving for, including much higher positional accuracies both for on-board position determination equipment and for the digital map. For example, to know which lane a vehicle is moving within requires a combined error budget of no more than 1 to 2 meters. Applications that use object avoidance (for example, to prevent collision with an oncoming car straying outside its lane), may require a combined error budget of less than 1 meter. Achieving this requires even smaller error tolerances in both the vehicle position determination, and in the map. The system is designed to use nominal absolute accuracies, in combination with higher relative accuracies, to achieve overall better accuracies, and to do so in an efficient manner. An object's position, with its higher relative accuracy, need only be loosely coupled to that same object's absolute position with its lower accuracy.

In the system of US 2008/0243378, vehicles contain one or more additional sensor(s), such as a camera, laser scanner, or radar, which are used to detect the presence and relative location of surrounding objects. The digital map or digital map database of the vehicle's navigation system includes at least some of the surrounding objects. The additional sensor(s) can sense the presence of at least some of these objects and can measure its relative position (distance and bearing) to those objects. This sensor information, together with the absolute information, is then used to determine the vehicle's accurate location, and if necessary to support features such as assisted driving or collision avoidance.

Depending upon the accuracy of the sensor, it is possible to identify, for example, a road sign and estimate its relative position to an accuracy of just a few centimeters relative to the vehicle's position (which may have an estimated absolute positional accuracy of a few meters). With current mapping accuracies, the same sign can be attributed in the database with a position having an absolute accuracy also on the order of a few meters. Thus the map matching problem becomes one of unambiguously identifying the object in the database with the appropriate characteristics within a search radius of, for example, 10 meters around the vehicle.

In such known systems, data concerning objects is usually stored in the form of an object identifier and absolute or relative co-ordinates of the object. Usually the objects are selected to be recognizable by the navigation system based upon measurements by the vehicle sensors. Some objects (for example a building, minor signs) may include only absolute positioning coordinates, whereas more important objects (such as street corners, major signs) may include both absolute positioning and relative positioning coordinates. Additional data representing additional identifying characteristics (such as color or size or shape or height of a sign) may also be stored.

In operation vehicle sensors detect the existence of one or more objects and possibly additional identifying characteristics (such as color or size or shape or height of a sign), measures the object's position, and uses this information to match to objects of similar characteristics and location in the map database.

Usually the object data stored in the database includes descriptive data describing one or more properties of the object, for example object type (e.g. a sign or building), location and sometimes other properties (color or size or shape or height of a sign). The properties may be determined using any of a variety of techniques and measurements, including visual inspection by an operator, and entered into the database. Subsequently the processor of an vehicle navigation system must apply processing techniques to raw data received from the in-vehicle sensors in order to identify object types and properties for matching with the database. Such object identification procedures can be relatively complex, and can place a significant processing burden on the vehicle navigation system.

Furthermore, the location of objects for which location data is stored in the database can change. Such changes, especially if relatively small, may not be picked up by a vehicle navigation system (e.g. the presence of a sign with expected properties may still be detected as expected by the vehicle navigation system) but can have a significant effect if it is desired to determine the location of a vehicle with high accuracy, as the location data for the object stored in the database may no longer be accurate.

The known systems described above can provide accurate and effective mapping and navigation. Nevertheless it is an aim of the present invention to provide an improved or at least alternative navigation system and/or method.

### SUMMARY OF THE INVENTION

In a first, independent aspect of the invention there is provided a vehicle navigation or mapping system comprising:—at least one sensor located on or in a vehicle and adapted to perform measurements to obtain sensor measurement data; a data store for storing reference sensor measurement data; and a processing resource adapted to determine whether the sensor measurement data matches the reference sensor measurement data and, if the sensor measurement data matches the reference sensor measurement data, to determine a relative or absolute spatial location of the vehicle from stored location data associated with the stored reference sensor measurement data.

By determining a match between sensor measurement data and reference sensor measurement data, the location of a vehicle can be determined from the surroundings of the vehicle. The determination of such a match does not require information concerning objects from which the measurement data has been obtained (although of course such information may also be used if desired), which can make for a simple and efficient process.

The sensor measurement data and the reference sensor measurement data may be of substantially the same or similar type. The sensor measurement data and/or the reference sensor measurement data may be subject to a transformation or other process prior to the determination of whether there is a match, for example a Fourier Transform process, an averaging, a filtering, or any other suitable signal processing procedure.

Sensor measurement data may comprise data that represents a physical measurement. An object type or descriptor is not considered in itself to be sensor measurement data. An object type or descriptor does not represent a physical measurement, although such an object type or descriptor may of course be selected or generated in dependence on the results of one or more physical measurements.

The processing resource may comprise, for example, a processor or a set of processing devices or modules, and may comprise software, hardware, or a combination of software and hardware. The reference sensor measurement data may comprise measurement data previously obtained using at least one sensor of substantially the same type as the at least one sensor located on or in the vehicle.

The location data may comprise the location of the at least one least one sensor of substantially the same type, or a vehicle on or in which the at least one sensor of substantially the same type was located, at the time the reference sensor measurement data was obtained.

The reference sensor measurement data may comprise 1-dimensional sensor measurement data as a function of position or time.

By using 1-dimensional data, storage and processing requirements may be reduced. The at least one sensor may be adapted to provide 1-dimensional sensor measurement data, for example as a function of position or time.

The reference sensor measurement data may comprise a plurality of sets of sensor measurement data, and the processing resource may be adapted to determine whether the measurement data matches any of the sets of reference sensor measurement data.

Each set of reference measurement data may be obtained from a respective landmark

Each set of sensor measurement data may comprise sensor measurement data obtained from a range of positions, for example a range of positions in the direction of travel of the vehicle.

The range of positions may be a range of substantially longitudinal positions. For example the range of positions may be a range of positions in the direction of travel of the vehicle. The sensor measurement data may comprise sensor measurement data for a time or distance window.

The range of positions may have a length of, for example between 0.5 m and 20 m, or between 2 m and 15 m, or between 5 m and 10 m

The at least one sensor may comprise a plurality of sensors, or may comprise a sensor arranged to perform measurements in a plurality of measurement directions. Each set of measurement data may comprise a plurality of sub-sets of sensor measurement data, each sub-set of measurement data being obtained by measurements by a respective different one of the sensors or from a respective laser scanner scan position.

The at least one sensor may comprise a plurality of sensors arranged to perform measurements at different sides of the vehicle and/or to perform measurements at different heights. Alternatively or additionally the at least one sensor may comprise a sensor, for example a laser scanner, arranged to perform a a plurality of measurements at different sides of the vehicle and/or at different heights.

The at least one sensor may comprise at least one pair of sensors, the pair of sensors being located and/or aligned symmetrically on each side of the vehicle. Alternatively or additionally the at least one sensor may comprise a sensor arranged to perform symmetrical measurements on each side of the vehicle.

The or each sensor may comprise a range sensor for measuring the distance of objects from the sensor. The or each sensor may comprise a laser sensor or radar sensor.

Each set of measurement data may comprise a plurality of sub-sets of sensor measurement data, the sub-sets of sensor measurement data representing measurements at different vertical positions, for example different heights relative to a roadway.

The processing resource may be configured to perform a correlation procedure correlating the sensor measurement data with the reference sensor measurement data.

The processing resource may be configured to determine that the sensor measurement data matches the reference sensor measurement data in dependence on the correlation procedure, for example whether the correlation is within a predetermined threshold.

The processing resource may be configured to determine further spatial location data from the vehicle by comparing at least one further property of the sensor measurement data with at least one further property of reference sensor measurement data that has been determined to match the sensor measurement data.

The at least one further property may comprise an amplitude of the sensor measurement data and the matching reference sensor measurement data. Thus, a lateral position of the vehicle may be determined. The reference sensor measurement data may comprise relative position data.

The at least one further property may comprise a plurality of relative amplitudes of the sensor measurement data and the matching reference sensor measurement data, different ones of the relative amplitudes being for measurements on different sides of the vehicle.

The reference sensor measurement data may comply with at least one distinctiveness criterion.

The at least one distinctiveness criterion may comprise a requirement that the measurement data comprises a spectrum including at least one peak, optionally at least two separated peaks.

The reference measurement data may comprise a plurality of sets of measurement data, each comprising a plurality of sub-sets of measurement data, and each sub-set of measurement data may comply with the at least one distinctiveness criterion.

The reference sensor measurement data may comprise a plurality of sets of measurement data, each comprising a plurality of sub-sets of measurement data, and the system may comprise means for selecting measurement data to be stored as a reference set of measurement data in dependence on whether each sub-set of the measurement data matches a predetermined distinctiveness criterion.

Each sub-set of the measurement data may comprise measurement data obtained using a respective different one of a plurality of vehicle sensors.

The system may further comprise means for receiving sensor measurement data from a plurality of vehicles, and amending the reference sensor measurement data in dependence on the sensor measurement data from a plurality of vehicles.

In another independent aspect of the invention there is provided a system for selecting sensor measurement data comprising a processing resource adapted to receive sensor measurement data obtained from at least one sensor located on or in a vehicle, the processing resource being adapted to determine whether data matches at least one distinctiveness criterion, and to store sensor measurement data that matches the at least one distinctiveness criterion as reference sensor measurement data.

The processing resource may be arranged to receive sensor measurement data from a plurality of vehicles, and to amending the stored reference sensor measurement data in dependence on the sensor measurement data received from the plurality of vehicles.

In another independent aspect of the invention there is provided a method of vehicle navigation or mapping comprising:—performing vehicle sensor measurements to obtain sensor measurement data; determining whether the sensor measurement data matches stored sensor measurement data; and if the sensor measurement data matches the stored sensor measurement data, determining a relative or absolute spatial location of the vehicle from stored spatial location data associated with the stored sensor measurement data.

The reference sensor measurement data may comprise measurement data previously obtained using at least one sensor of substantially the same type as at least one sensor located on or in the vehicle.

The reference sensor measurement data may comprise 1-dimensional sensor measurement data as a function of position or time.

Each set of sensor measurement data may comprise sensor measurement data obtained from a range of positions, for example a range of positions in the direction of travel of the vehicle.

The measurements may be at different sides of the vehicle and/or at different heights.

The method may further comprise determining further spatial location data from the vehicle by comparing at least one further property of the measurement data with at least one further property of reference sensor measurement data that has been determined to match the sensor measurement data.

The at least one further property may comprise an amplitude of the sensor measurement data and the matching reference sensor measurement data.

The method may further comprise receiving sensor measurement data from a plurality of vehicles, and amending the reference sensor measurement data in dependence on the sensor measurement data from the plurality of vehicles.

In a further independent aspect of the invention there is provided a method of selecting sensor measurement data comprising receiving sensor measurement data obtained from at least one sensor located on or in a vehicle, determining whether the sensor measurement data matches at least one distinctiveness criterion, and storing sensor measurement data that matches the at least one distinctiveness criterion as reference sensor measurement data.

In another independent aspect of the invention there is provided a computer program product comprising computer readable instructions that are executable to perform a method as claimed or described herein.

In a further independent aspect of the invention there is provided a computer program product comprising a database storing at least one set of reference sensor measurement data obtained from at least one sensor located on or in a vehicle, the at least one set of reference sensor measurement data complying with a distinctiveness criterion.

There may also be provided an apparatus, system or method substantially as described herein with reference to the accompanying drawings.

Any feature in one aspect of the invention may be applied to other aspects of the invention, in any appropriate combination. For example, apparatus or system features may be applied to method features and vice versa.

### BRIEF DESCRIPTION OF THE FIGURES

Embodiments of the invention are now described, by way of non-limiting example, and are illustrated in the following figures, in which:

FIG. 1 is a schematic illustration of a vehicle including a navigation or mapping system according to one embodiment;

FIG. 2 is a schematic illustration of certain components of the navigation or mapping system of FIG. 1;

FIG. 3 is a graph of a sub-sets of measurement data obtained from a sensor of the system of FIG. 1;

FIG. 4 is a flow chart illustrating in overview a location-determining process;

FIG. 5 shows various graphs illustrating a correlation procedure;

FIG. 6a is a schematic illustration of a vehicle mounted navigation system being used to obtain measurement data;

FIG. 6b is a graph of measurement data and reference data for the system of FIG. 6a;

FIGS. 7a and 7b are illustrations of survey vehicles; and

FIGS. 8a and 8b are graphs of measurement data selected for use as reference data.

### DETAILED DESCRIPTION OF THE FIGURES

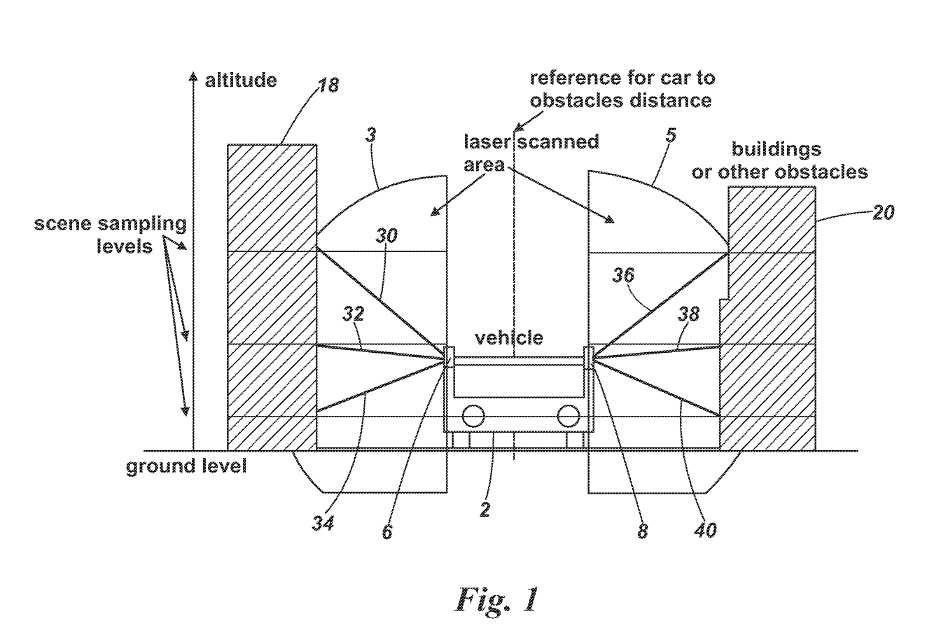

FIG. 1 is an illustration of a vehicle 2 that includes a vehicle navigation system 4 and associated laser sensors in the form of laser scanners 6, 8. The laser sensors are arranged symmetrically on each side of the vehicle, with one of the scanners 6 arranged on one side of the vehicle 2 and the other of the scanners 8 arranged on the other side of the vehicle 2. Each of the scanners comprises a laser transmitter for transmitting a pulsed or continuous beam of laser radiation, a laser detector for detecting reflected laser radiation, and a processor for controlling the scanning of a laser beam by the scanners and for processing the results of measurements. The laser sensor processor is operable to determine the distance of a surface of a building 19, 20, object or other surroundings with which the laser sensor is aligned and from which the laser radiation is reflected using, for example, time-of-flight measurements or other known ranging techniques. Each laser scanner is configured to scan the laser beam across a laser scanned area 3, 5 and to perform range measurements along different directions within the laser scanned area. In the embodiment of FIG. 1, range measurements along three different selected measurement directions 30, 32, 34, 36, 38, 40 on each side of the vehicle are used. Any suitable laser scanners 6, 8 can be used, for example Sick (RTM) LMS291-505 scanners.

In an alternative embodiment, a plurality of sensors is provided on each side of the vehicle, each sensor arranged to perform measurements in a respective, fixed measurement direction.

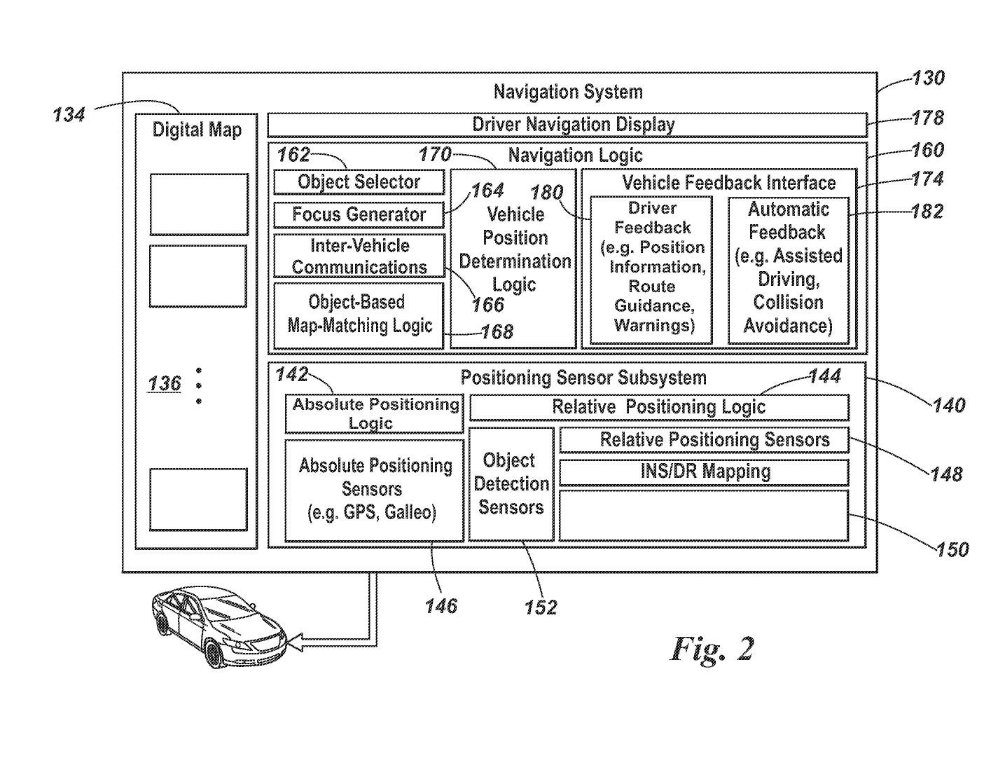

The arrangement and operation of the laser scanners in determining the position of the vehicle will be considered in more detail below. Firstly the navigation system is considered in more detail with reference to FIG. 2.

The navigation system 4 can be placed in any vehicle, such as a car, truck, bus, or any other moving vehicle. Alternative embodiments can be similarly designed for use in shipping, aviation, handheld navigation devices, and other activities and uses.

The navigation system 4 comprises a digital map or map database 134, which in turn includes a plurality of sets of reference sensor measurement data, also referred to as landmark data 136.

The navigation system 4 further comprises a positioning sensor subsystem 140, which includes a mix of one or more absolute positioning modules or other logics 142 and relative positioning modules or other logics 144. The absolute positioning module 142 obtains data from absolute positioning sensors 146, including or example GPS or Galileo receivers. This data can be used to obtain an initial estimate as to the absolute position of the vehicle.

The relative positioning module obtains data from relative positioning sensors 148, in this case the laser sensors 6, 8 (any other suitable type of sensor can be used, for example radar, laser, optical (visible) or radio sensors). This data can be used to obtain the relative position or bearing of the vehicle compared to one or more landmarks or other features for which the digital map includes sets of landmark sensor measurement data. Additional relative positioning sensors 150 can also be provided, for performance of further relative position measurements.

A navigation logic 160 includes a number of additional, optional components. A selector 162 can be included to select or to match which sets of landmark sensor measurement data are to be retrieved from the digital map or map database and used to calculate a relative position for the vehicle. A focus generator 164 can be included to determine a search area or region around the vehicle centered approximately on an initial absolute position. During use, a map match can be performed to identify landmark sensor measurement data within that search area, and the information about those objects can then be retrieved from the digital map. A communications logic 166 can be included to communicate information to or from the navigation system of the vehicle.

A map matching module or other logic 168 can be included to match sensor measurement data to stored reference sensor measurement data.

A vehicle position determination module or other logic 170 receives input from each of the sensors, and other components, to calculate an accurate position (and bearing if desired) for the vehicle, relative to the digital map, and landmarks or other features. A vehicle feedback interface 174 receives the information about the position of the vehicle. The information can be used for driver feedback 180 (in which case it can also be fed to a drivers navigation display 178). This information can include position feedback, detailed route guidance, and collision warnings. The information can also be used for automatic vehicle feedback 182, such as brake control, and automatic vehicle collision avoidance.

The digital map 134 database stores the usual data representing street layouts, points of interest and a variety of other geographical features including buildings and other objects. In addition the digital map database stores sensor measurement data obtained from previous sensor measurements by (in this example) laser sensors.

Returning to consideration of FIG. 1, in operation the laser sensors 6, 8 transmit laser signals that are reflected by surfaces (for example surfaces of buildings, walls, signs, trees or other features) and received by the laser sensors. The laser sensors determine the distance of the surfaces from which the laser signals are reflected along the selected measurement directions 30, 32, 34, 36, 38, 40 using known techniques and output sensor measurement signals representative of the determined distances and thus represent the surroundings of the vehicle on the road. As the vehicle travels, the measurement signal obtained from each of the sensors 6, 8 along the measurement directions 30, 32, 34, 36, 38, 40 varies as the distance from the vehicle to roadside features varies. In the example of FIG. 1, the surfaces on both side of the vehicle are sampled at regular distances to obtain 6 slices (or 4 slices if fewer sensors are provided) of data from each side of a vehicle.

An additional 2 slices of data are obtained from the surface of the road and from any surfaces (for example the underside of bridges) over the vehicle, by additional sensors in a variant of the embodiment of FIG. 1.

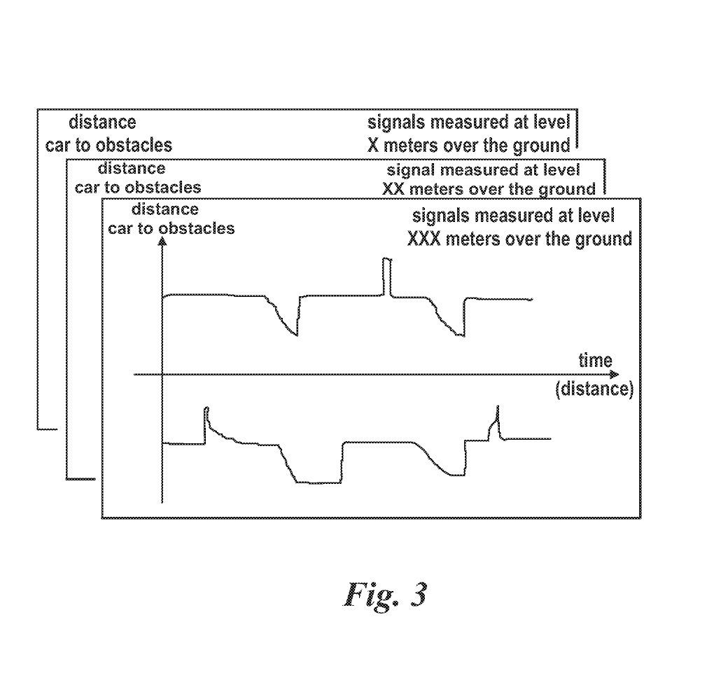

A graph of the measurement data obtained for the measurement directions 30, 36 is shown in FIG. 3. The measurement data obtained for one of the measurement direction 30 is plotted as the top line in the graph, and the measurement data obtained for the other measurement direction 36 is plotted as the bottom line of the graph. The two measurement directions 30, 36 (and the sensors 6, 8) are at symmetrical positions and alignments at opposite sides of the vehicle. The measurement directions and sensors arranged so that a reflecting surface located at the same vertical height and lateral displacement from the left or right hand side of the vehicle would be detected by both sensor 6, 8. The other pairs of measurement directions 32, 38 and 34, 10 are arranged in similar fashion but are such as to scan different heights to the pair 30, 36.

In the example of FIG. 1, the sensor are aligned at an angle to the road surface. Knowing the height and angle of alignment of the sensors, it is possible to determine the height above the ground of the surface from which a reflected signal is received, if desired.

The measurement data obtained from each sensor comprise 1-dimensional signals (in this case distance of to a roadside object or other reflecting surface) recorded as function of time or distance (for example, distance along a route), which can provide for reduced data storage capacity requirements, and relatively fast processing.

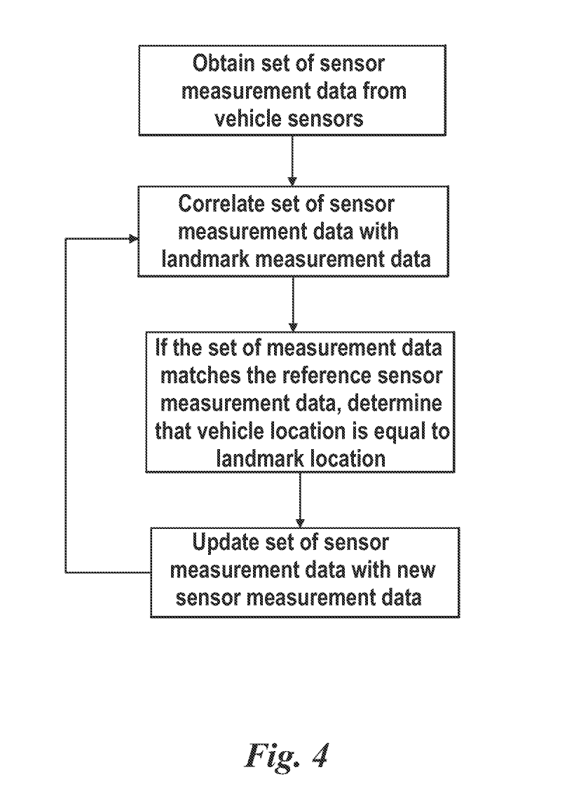

The measurement data obtained from each of the sensors is compared to stored sensor measurement data to determine whether the sensor measurement signals match the stored reference measurement data, also referred to as landmark data, in a positioning process. The positioning process is illustrated in overview in the flow chart of FIG. 4.

The goal of the positioning is to find a correlation between the continuously acquired set of measurement data from the vehicle sensors and landmark measurement data stored in the database and then compute the relative position of vehicle against the landmark from position data for the landmark stored in the database 134. As the vehicle surroundings are sampled by the laser sensors 6, 8, with centimeter level resolution the correlation procedure can enable the determination of relative position of measured signals (and thus the vehicle) against landmark signals from the database with high (ADAS compliant) longitudinal accuracy.

An initial determination of vehicle position can be obtained from, for example, GPS measurements or a localization system based on cellular network. That initial positioning procedure reduces the area of possible locations of the vehicle and allows the selection of limited number of sets of landmark measurement data for use in comparison with a user vehicle's measurement data to obtain a more accurate position of the vehicle.

Usually for each of the sensors 6, 8 and measurement directions the measurement data obtained for that sensor is compared to the landmark measurement data obtained for a corresponding sensor and measurement direction, and if the measurement data for each of the sensors are found to match the landmark measurement data then the position of the vehicle can be determined from position data for the landmark stored in the database 134. In one mode of operation a correlation procedure is used to determine whether there is a match between measurement signals from a sensor and stored landmark measurement signals from corresponding sensor. Any suitable correlation procedure, or any other suitable type of signal matching procedure, can be used.

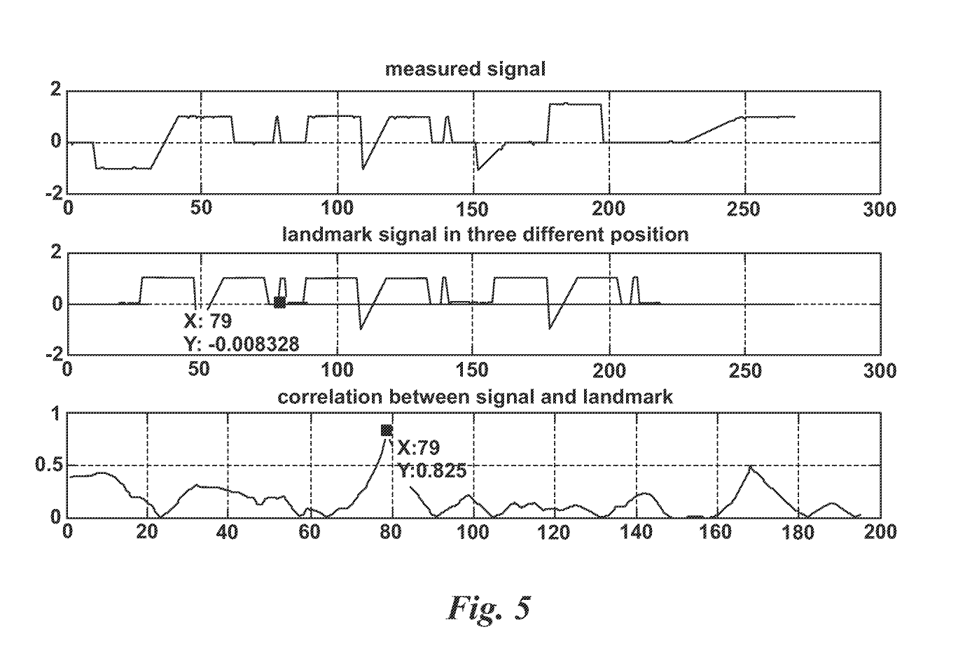

The results of a correlation procedure are illustrated in FIG. 5, which includes three graphs.

The top graph is a plot of a set of stored landmark sensor measurement data obtained by one laser sensor of a reference vehicle as a function of travel distance (or time).

In operation, a rolling window of live measurement data for each sensor of the vehicle 2 is maintained by the map matching module 168. Each new measurement by the sensor causes the window of measurement data to be updated on a first-in-first-out basis. The middle graph is a plot of a window of sensor measurement data as a function of longitudinal travel distance (or time) at three different vehicle positions (or times), by way of example.

Each time the window of live measurement data is updated with new sensor measurement data, the map matching module 168 performs a correlation procedure by calculating the value of a correlation function correlating the set of stored landmark sensor measurement data with the window of live measurement data.

The bottom graph is a plot of the value of the correlation function as a function of position of the vehicle 4. In this example, a maximum value of the correlation function at a longitudinal travel distance of x=79. The maximum value of the correlation function is greater than a predetermined threshold and thus in this example it is determined that the measurement data successfully matches the stored landmark measurement data. The location of the vehicle 4 for which the maximum of the correlation value was obtained is determined to be the stored location associated with the stored landmark sensor measurement data (in this example, the location of the reference vehicle when the landmark sensor measurement data was originally recorded by the reference vehicle).

Usually a similar correlation procedure to that described in relation to FIG. 5 is performed for each of the sensors and selected measurement directions. If the correlation between the window of sensor measurement data and corresponding stored landmark sensor measurement data is greater than the predetermined threshold for each of the sensors then it is determined that there is a match between the sensor measurement data and the stored landmark sensor measurement data.

In some cases, measurement data from one or more of the sensors can be distorted, for example due to the presence of a parked vehicle or a pedestrian. In some embodiments the map matching module 168 is configured to determine whether there are anomalies in the correlation results for any of the sensors, and if one or more of the sensors seem to be providing anomalous results, to ignore the data those results in determining whether there is a match with the stored landmark measurement data. Thus, if a parked vehicle or pedestrian interferes with the measurements for a sensor and measurement direction, the map matching module 168 is able to ignore the data affected by the parked vehicle or pedestrian and still conclude that there is a match to the stored landmark measurement data. As scans are being performed at different heights (see for example FIG. 1) in practice it is likely that even if the measurements of some of the sensors are affected by the presence of extraneous objects such as parked vehicles or pedestrians other of the sensors will be unaffected, providing for a robust procedure.

In practice it is likely that the stored landmark measurement data and the live measurement data will have been registered by vehicles travelling at different speeds and thus the distance to time scale factor could be different for the landmark signals and the actual signals (effectively, one could be stretched or compressed with respect to the other). In such cases, the map matching module 168 is operable to apply speech recognition based techniques, for example Dynamic Time Wrapping (DTW) techniques, or other techniques that allow for the stretching or compression of signals, and allows different length signals (for example signals obtained from vehicles travelling at different speeds) to be compared.

In the embodiment of FIG. 1, the measurement data is compared directly to corresponding, stored measurement data of the same or similar type (for example obtained using the same or similar types of sensors). The procedure does not require any information concerning the objects from which the measurement data has been obtained (for example whether it is a sign or a building) and indeed a set of landmark sensor measurement data can include data from several different objects or types of object (for example a set of landmark measurement data might include data obtained from a sign and several buildings or parts of buildings).

Thus, the generation and storage of landmark data (described in more detail below) can be a relatively simple, automated procedure dependent on the nature of the measurement signals themselves, and does not require complex or manual processing to determine the identity and nature of objects for storage in the database. Furthermore, in the embodiment of FIG. 1, the processing of measurement signals from vehicle sensors during normal operation does not require an intermediate processing step to determine the identity and nature of objects from which the signals are obtained, instead the signals can be compared directly to the previously obtained measurement data.

In the example illustrated in FIG. 5, the amplitude of the measurement signals are offset by an offset amount before performing the correlation procedure. For example, the range measurements by the laser sensor may be offset, so that the first measurement of the window has a value equal to zero or equal to a predetermined value (for example equal to the corresponding value of the set of landmark measurement data). Alternatively the range measurements by the laser sensor for may be offset so that the average amplitude across the window is equal to the average amplitude of the stored landmark measurement signal.

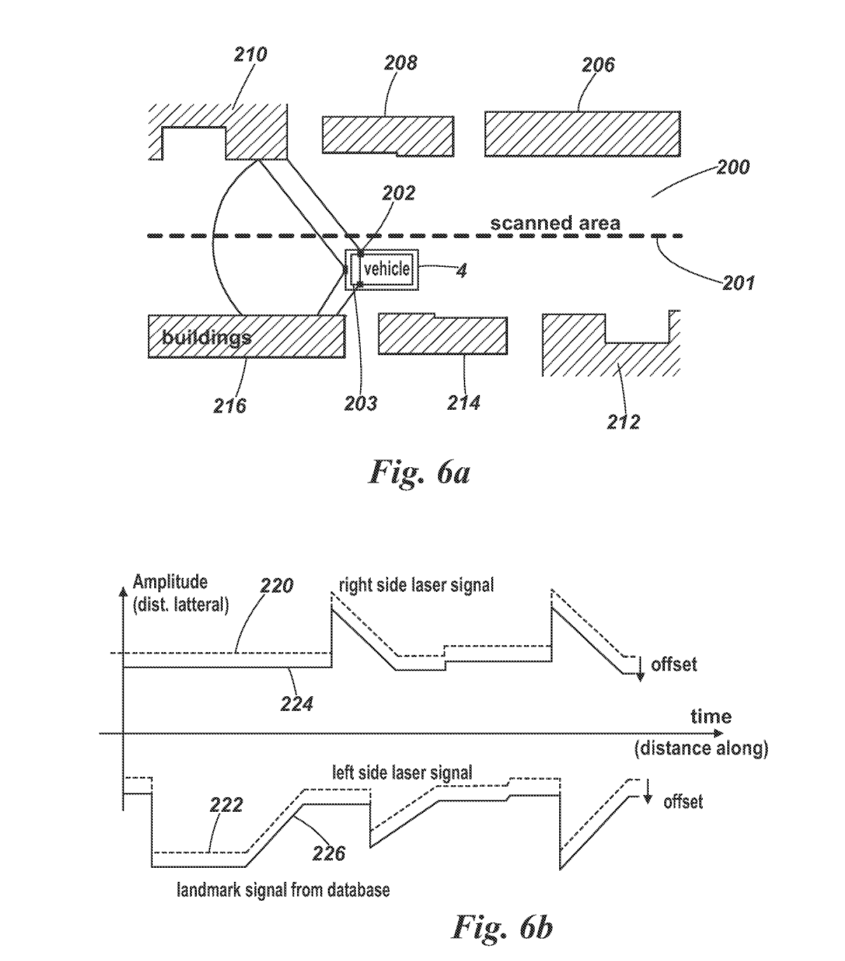

As the amplitude of signal is proportional to distance from car to the environment element (for example, buildings, trees, signs) the relation of the amplitude of correlated signals from opposite sides of vehicle and landmark signals allows the computing of the relative lateral position of vehicle against the landmark. For example, in a further process performed by the map matching module 168, the offset amplitudes for the measurement signal can be used to determine a lateral position of the vehicle (for example, a lateral position of the vehicle relative to the centre line of the road), as described with reference to FIGS. 6a and 6b.

In the example of FIG. 6a, the vehicle 4 is travelling along a carriageway of a road 200, offset by a lateral position y from the centre line 201 of the road. In this case, data from a single pair of sensors 6, 12 symmetrically positioned and aligned on the left and right hand sides of the vehicle is considered. The lines 202, 203 indicate the lines along which range measurements are performed by the sensors 6, 12. The positions on the surroundings of the vehicle (in this case buildings 204, 206, 208, 210, 212, 214, 216) to which the sensors have performed range measurements for a time window as the vehicle 4 has travelled along the road are indicated by dotted lines on the surroundings.

The range measurements by the sensors 6, 12 for the time window are plotted in FIG. 6b as dotted lines 220, 222. The centre line of the graph represents zero distance from the centre line 201 of the road, with positive distances (above the centre line of the graph) representing distances to the right of the centre line 201 and negative distances (below the centre line) representing distances to the left of the centre line 201.

The stored landmark measurements for sensors corresponding to sensors 6, 12 are plotted as solid lines 224, 226 in FIG. 6b. The stored landmark measurements are representative of the measurements obtained from a vehicle travelling along the centre line of the road 201. It can be seen in FIG. 6b that the measurements 220, 222 by the sensors 6, 12 correlate well with the stored landmark measurements 224, 226, but that there are offsets between the measurements 220, 222 and the stored landmark measurements 224, 226. Those offsets correspond to a lateral offset of the vehicle 4 from the centre line of the road, and are used by the map matching module 168 to determine that lateral offset.

The length of the time (or distance) window used for a particular landmark in the database can be selected in dependence on, for example, properties of the road or surroundings. For example a longer window may be used for landmarks on a relatively fast route with relatively unchanging surroundings (for example on a motorway) and a shorter window may be used for landmarks on a route in an urban environment, with varied surroundings and slower vehicle speeds.

Further consideration is now given to the gathering and selection of the reference landmark measurement data. It is a feature of the described embodiment, that such landmark data can be generated, selected and stored in an automatic procedure.

In one mode of operation one or more survey vehicles 300 equipped with laser scanners are used to gather initial reference landmark measurement data. In order for the positioning system to work for a user vehicle, the navigation system installed in the vehicle needs to contain, or have access to, a database 134 of reference landmark measurement data and a first version of database 134 is usually built before navigation devices are made available to users.

FIGS. 5a and 5b show two examples of survey vehicles equipped with laser scanner devices 302, 304, 306, 308, 310. Each of the laser scanner devices can include one or more laser sensors having a selected arrangement. The laser scanner devices on the survey vehicle are usually of the same or similar type and in the same or similar arrangement as laser sensors on user vehicles. For example, in a further embodiment the laser sensors are in substantially the same arrangement on the survey vehicle as in the user vehicle of FIG. 1.

The measurements by the laser sensors of the survey vehicle can be processed using substantially the same methods, algorithm and rules as are used by laser sensors of user vehicles, for example so that measurements by the survey vehicle and a user vehicle in substantially the same locations would produce sensor measurement data having substantially the same form and amplitude.

In the process of landmark generation the continuous signals from the laser scanner devices of the survey vehicle are converted into sets of 1-dimensional signals (as a function of distance of time) and analyzed using a constant length time window.

Portions of the signals are selected and stored as sets of reference landmark measurement data (one sub-set of data from each laser sensor and/or measurement direction). Each set of reference landmark measurement data is stored with spatial location data representative of the vehicle location at which the data was obtained, for example X, Y, Z attributes defining geographic position with ADAS-compliant accuracy. Each set of reference landmark measurement data can be stored in the database 134 with such geo-reference or other location information as a landmark.

As already mentioned above, there is no need to know what is represented by a landmark. However in the embodiment of FIG. 1, the measurement signals that are stored as landmark reference measurement signals are selected so that properties of the signals themselves meet certain predetermined criteria. For example, measurement signals are selected that are distinctive and distinguishable from signals obtained from neighboring locations.

In one example, the measured sensor signal across a time or distance window selected for storage as reference measurement data is variable and the size of nature of the variability is different at different points across the time or distance window. It has been found that in practice suitable signals can be obtained from areas that include one or more of:—a corner of a building, a tree, a lamp, a column or a road sign. However, there is no need to determine the source of suitable signals, instead the signals can be selected automatically in dependence upon the signal properties themselves.

Any suitable signal processing techniques can be used to select the sensor signals to be used as reference landmark measurement data. In one example, sets of sensor signals provide different slopes and/or Dirac impulse function-like features are identified and selected. Such signal features can be identified and analyzed using for example Short Time Fourier Transform (STFT) or wavelet signal analysis. In one mode of operation signals are selected for use as landmarks if the spectrogram of the signals contain at least two modes with different frequency characteristics, for example at least two isolated frequency modes as a function of time.

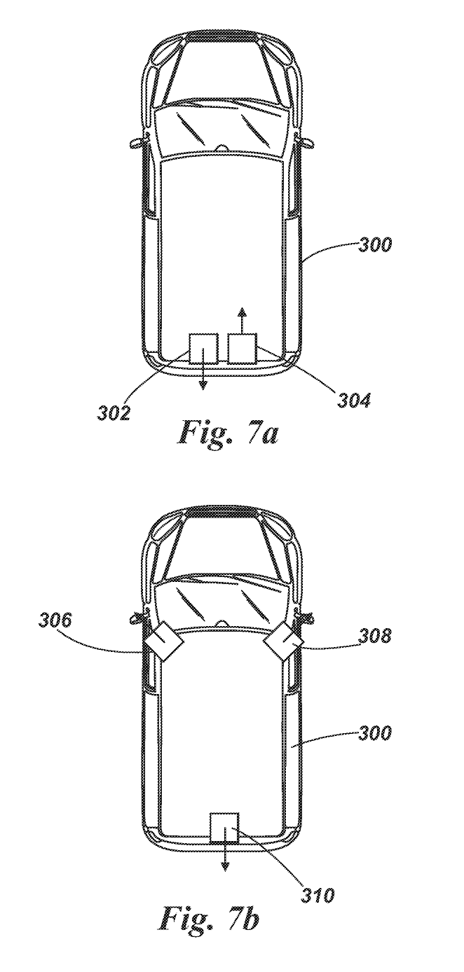

FIG. 7a shows measurement data from a single sensor and measurement direction, as a plot of range measurement as a function of time (or distance in the direction of vehicle travel). The measurement data could for example represent range measurements to a building elevation, building corner, and a post or trunk (represented by the short impulse towards the right hand side of the plot). A spectrogram of the measurement data of FIG. 7a is provided in FIG. 7b and shows frequency characteristic changes with time. It can be seen that three distinct and separated peaks in the frequency spectrum are obtained, making the measurement data suitable for use in a set of reference landmark signals.

Usually the measurement data from each of the sensors and/or measurement directions for the window is analyzed and if the measurement data satisfies the predetermined or otherwise selected criteria, then the set of measurement data is used as a set of landmark measurement data. The process of spectral analysis can be performed successively or substantially simultaneously on signals from different sensors (different slices) and the signals from all sensors (all slices) should meet the requirements.

In one mode of operation, a set of landmark measurement data is selected for each selected length of road, and the sets of landmark measurement data may be obtained from roughly equally spaced locations along the length of road. The system may be configured so that more, or more closely spaced, landmarks are provided in the database for busier areas or areas with more junctions (for example in urban areas) and fewer landmarks are provided in the database for lengths of roads with fewer or no junctions (for example stretches of motorway).

Once the system has been deployed to users, the maintenance of the landmark database can be performed in two different ways. Firstly, survey vehicles such as those used for initial database build can be used to confirm or update landmark data.

Secondly measurement data recorded by sensor devices installed in users' vehicles can be used to update the database. As each user device/vehicle will be equipped with required sensors and will perform detection and positioning tasks that are similar or identical to those that were used to create the database, the results of such tasks can be transferred back to a database production unit (for example, at a central server) and used to update the database. The updated database or updated entries in the database can subsequently be provided by the server to user devices.

The data may be sent to the central server via wired or wireless communication. For instance, many portable navigation devices can be docked in a PC or other computer docking station allowing transfer of data with a central server via an internet connection to the PC or other computer, and providing for software, map and database updates or installations. Similar transfers of data and updates or installations can be provided via a wireless internet connection if the user's system is wirelessly enabled.

There are various scenarios with regard to the use of user data with regard to the database, for example: (1) The result of the calculations on the user device is similar to the signatures stored in landmark database—this means that probably there is no change in the area; and (2) The result of the processing by the user device differs from the signatures stored in the landmark database—this difference may reflect a temporary or permanent change in the configuration of landmark in the area. The recorded signals are provided with the time of recording and then reported to a database production unit, for example at a central server. Having a number of such records from different users spread over time allows a decision to be made (either automatically or by a user) as to whether the change in the landmark was temporary or permanent. If the change seems to be permanent then the landmark data can be amended by the server and the amended landmark data distributed to user devices. The landmark data can be amended based upon the user data or a survey vehicle can be sent to re-measure the landmark to provide the amended data.

A summary of the invention, at least in embodiments thereof, will now be described.

Embodiments of the invention relate to a method for precise positioning of the vehicle basing on the detection of landmarks in the vicinity of the vehicle, and more specifically basing detection and positioning of landmark on the transformation of 3D laser scans into slices of 1D signals. Aspects of the invention relate to following: (i) transformation of 3D laser scan data into slices of 1D signals allowing detection of recorded landmarks and then positioning the vehicle in relation to these landmarks; (ii) format of landmark representation in database; (iii) method of landmark representation generation; and (iv) positioning against specified landmark representation. The technical problems solved by embodiments of the invention include: positioning based on detection of landmark objects; generation of landmark representation from 3D laser scan; detection of landmark in registered laser scanned environment; initial creation of landmark database; and maintenance of landmark database. The invention will typically be used in a vehicle positioning module for use in a navigation system.

### Vehicle Positioning Concept

Laser scanner mounted on vehicles allow for registration information about road and 3D road environment. Due to large amount of 3D data this kind of information is not suitable for storing in the database in its original form. Approach proposed herein describes rules of selection data for landmark generation, concept of landmark identification and positioning continuously received data to landmark from database.

### Data Registration and Landmark Construction

Laser scanners on vehicle register data that represents surroundings of the road and even road surface. To reduce amount of data only set of slices is registered. The vertical surfaces on both side of the vehicle are sampled in regular distances to generate to obtain 4 to 6 slices from each side of a vehicle. Additional 2 slices are register for vertical surface of the road and for surface over the vehicle. Obtained set of 12 to 16 slices could be treated as set of single dimensional signals and analyzed using signal processing method. Single slice could be affected by presence of moving or parked cars or any different temporary existed obstacles thus there is necessary to collect more than one slice to cover most of the modeled surroundings.

Slices from 3D data were taken on defined altitude over the ground and using laser set to defined direction from driving direction (which is most often parallel to road centerline). Defined sampling position makes this technique invariant to variance of laser direction orientation.

FIG. 1 shows vehicle surroundings scanning with laser scanner with features for landmark definition. FIG. 3 shows a package of signals, for example, for landmark generation, recognition, etc, taken on known position over the ground.

Registration of the data for landmark generation and for navigation—positioning against landmarks is made using the same fully automatic process as in landmark collecting.

In the process of landmark generation the continuous signals from laser scanner converted into set of single dimensional signals. These signals have been formed into limited length package that could be easily distinguished from its neighbors in process of positioning. The package of signal is marked with X, Y, Z attributes defining ADAS compliant accuracy geographic position of these package. Signals package with geo-reference information is stored in the database as a landmark. There is no need to know what exactly is represented by the landmark but for easy and sure landmark identification registered signal should meet some criteria.

### Signal Features for Landmark Generation

Registered signal selected for the landmark should be variable and character of its changes should be different for different part of the registered signal. Signal that meets these features could be obtained from area with corner of the building, single trees, lamps, columns or road sign, etc. In domain of signals this kind of changes could be represented as different slopes and Dirac alike impulses. These signal features are feasible to compute and analyze using Short Time Fourier Transform (STFT) or using wavelet signal analysis. The spectrogram of the signals selected for landmark should contain at least two isolated along time axis modes with different frequency characteristics.

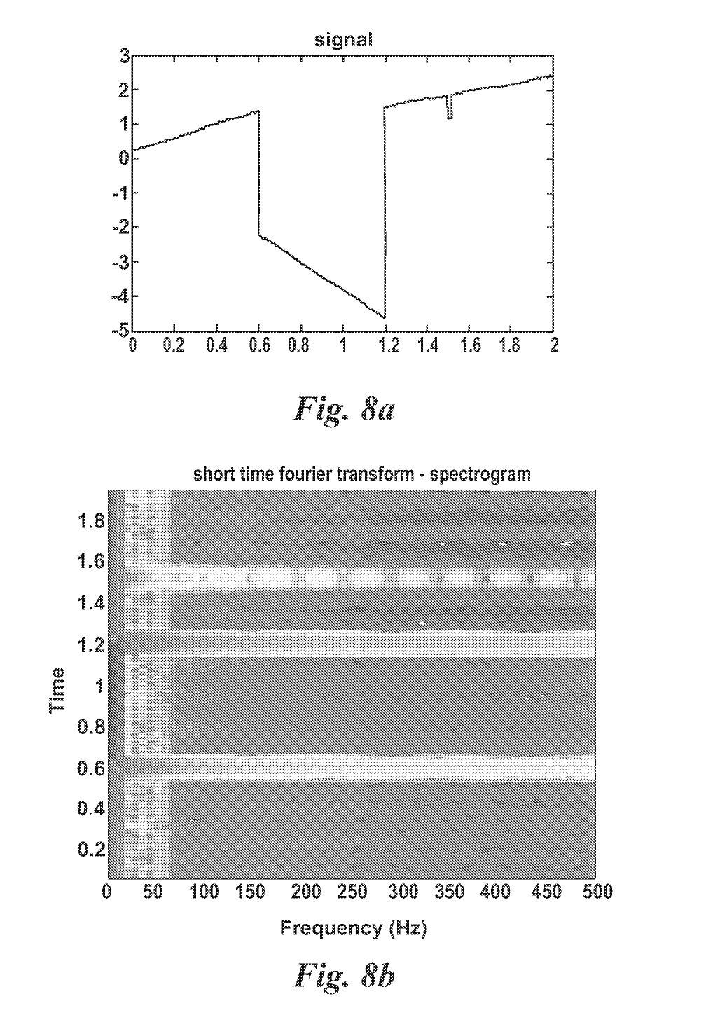

FIGS. 8a and 8b show example of single signal (the one selected form set of collected slices) that could represent theoretical building elevation, building corner and post or trunk represented by short impulse, and its spectrogram showing frequency characteristic changes along signal.

Continuous signals acquired from laser scanners slices are analyzed using constant length time window, and when meets chosen criteria currently selected signals is chosen to form the landmark. The process of spectral analysis is simultaneously performed on all slices and all slices should meet the requirements. If there are no signals that meet the requirements for too long time (the time herein corresponds to road distance in reality).

### Positioning

The goal of the positioning is to find correlation between continuously acquired set of signals and landmark from database and then compute relative position of vehicle against landmark from database. Vehicle surrounding is sampled by laser scanner with centimeter level resolution thus the correlation of signals allows finding relative position of measured signal (and indirectly the vehicle) against landmark from database with high (ADAS compliant) longitudinal accuracy.

FIG. 5 shows the longitudinal shift between landmark and measured signal computed by finding maximum value of correlation function.

The initial assumption for the system functionality is that the positioned system is equipped with geo positioning system with high variance of position estimation, i.e. GPS, or localization system based on cellular network. Initial positioning reduces area of possibly location of vehicle and allows to selection of potential landmark against which the vehicle will be positioned. The landmark and actual signal could be registered with different speeds thus the distance to time scale factor could be different. In such case the landmark searching will be realize using signal recognition method called Dynamic Time Wrapping (DTW) typically used in speech recognition. This technic allows comparing different length signals. In present approach a signals obtained from cars with different speeds. To remove influence of lateral positioning signals for correlation finding procedure should have removed average component (offset). The offset is used in next process of lateral positioning.

Amplitude of signal is proportional to distance from car to the environment element (i.e. buildings elevation, trees). Relation of amplitude of correlated signals representing opposite side of vehicle and landmark signals allows computing relative lateral position of vehicle against landmark. FIG. 6a shows a scanning area with marked surfaces for which distance to vehicle is converted into the 1D signals. FIG. 6b shows signals registered as in previous figure compared to time (longitudinal) correlated landmark signal. Signal offset allows for positioning against landmark.

### Landmark Database

In order for the positioning system to work on user vehicles/device, the device needs to contain the database of landmarks that are used for relative positioning. Hereafter we propose how such database can be built and maintained.

### Initial Build of the Landmark Database

The first version of database needs to be built before devices are available to users. For this we propose to use a survey vehicle equipped with laser scanners. The data from laser scanners needs to be then processed using exactly the same methods, algorithm as rules as will be used in user devices, guaranteeing that the user devices can utilize such database.

We propose two configurations of laser scanners onboard the survey vehicle that can be used to build the landmark database used in our invention.

Configuration 1: Two laser scanners at the back of the van. First laser looking 45 degrees down and back. Second laser looking 45 degrees up and front. This configuration is depicted in FIG. 7a.

Configuration 2: Three laser scanner. Laser at the back is looking 90 degrees down. Laser on the left is looking 45 degrees up and left. Laser on the right is looking 45 degrees up and right. This configuration is depicted in FIG. 7b.

### Maintenance of the Landmark Database

Once the system is deployed to users, the maintenance of the landmark database can be performed twofold. First the survey vehicles used for initial database build can be reused. Second option is to use the community input data recorded by users. Since each user device/vehicle will be equipped with required sensors and will perform the detection and positioning tasks identical to those that were used to create the database, the results of such tasks can be transferred back to database production unit and used to update the database.

Let us consider two scenarios:

1. The result of the calculations on the user device is similar to the signatures stored in landmark database—this means that probably there is no change in the area.

2. The result of the calculations on the user device differs from the signatures stored in landmark database—this difference may reflect a temporary or permanent change in the configuration of landmark in the area. New recorded signal is enhanced with the time of recording and then reported to the database production unit. Having a number of such records from different users spread over time allows making the decision if this change was temporary or permanent.

Advantages and technical developments of the invention can be summarized as:
Basing detection and positioning of landmark on the transformation of 3D laser scans into slices of 1D signals.
Landmarks are not categorized nor attributed. We don't require the knowledge of what the landmark represents for the invention to work. Not requiring such knowledge means all processing around the ‘landmark signal’ concept is automated. Only specified signal features need to be computed to select recorded signal set as a landmark.
The community input gathered is objective (does not require human interaction), thus it is more reliable than community input gathered via user interaction.

A skilled person will appreciate that variations of the disclosed arrangements are possible without departing from the invention.

For example, although the above embodiments have been described in relation to a general navigation device, it will be appreciated that the invention may be applicable to a wide range of mapping and/or navigation applications. For example, the application may be used in relation to a mapping system running on a personal computer, laptop, PDA, mobile phone or other device with computational functionality, for example, akin to systems that provide applications such as Google (RTM) maps, Bing (RTM) maps, OVI (RTM) maps or the like.

Furthermore, it will be appreciated that although certain process steps may be described as being performed by a processing resource on a navigation device or a server, it will be appreciated that some or all of the processing may be performed on the navigation device or the server or split in any way between the two (or other) resources.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A positioning system for use in a vehicle navigation or mapping system, comprising a data store for storing reference sensor measurement data and a processing resource configured to:
obtain one or more sets of sensor measurement data from at least one sensor located on or in a vehicle, each set of sensor measurement being indicative of the distance of objects in an environment around the vehicle from the sensor, and each set of sensor measurement data comprising data obtained from a range of positions in a time or distance window along the direction of travel of the vehicle;
perform a correlation procedure correlating the one or more sets of sensor measurement data with the reference sensor measurement data; and
determine a relative position of the vehicle against stored location data associated with the stored reference sensor measurement data in dependence on the correlation procedure.

2. The positioning system according to claim 1, wherein the processing resource is configured to obtain sets of sensor measurement data representative of the environment at a plurality of different heights.

3. The positioning system according to claim 1, wherein the processing resource is configured to obtain sets of sensor measurement data representative of the environment on both sides of the vehicle.

4. The positioning system according to claim 1, wherein the processing resource is configured to obtain a plurality of sets of sensor measurement data representative of the environment on both sides of the vehicle and at a plurality of different heights.

5. The positioning system according to claim 1, wherein the reference sensor measurement data comprises measurement data previously obtained using at least one sensor of substantially the same type as the at least one sensor located on or in the vehicle.

6. The positioning system of claim 1, wherein the correlation procedure comprises determining a maximum value of a correlation function, said maximum value being representative of a longitudinal shift between the one or more sets of sensor measurement data and the reference sensor measurement data.

7. The positioning system of claim 1, wherein the processing resource is configured to determine a relative amplitude of the correlated one or more sets of sensor measurement data and the reference sensor measurement data, said relative amplitude being representative of a lateral offset.

8. The positioning system of claim 3, wherein the processing resource is configured to determine a relative amplitude of the correlated one or more sets of sensor measurement data and the reference sensor measurement data on both sides of the vehicle, said relative amplitude being representative of a lateral offset.

9. A positioning method for use in a vehicle navigation or mapping system, comprising:
obtaining one or more sets of sensor measurement data from at least one sensor located on or in a vehicle, each set of sensor measurement being indicative of the distance of objects in an environment around the vehicle from the sensor, and each set of sensor measurement data comprising data obtained from a range of positions in a time or distance window along the direction of travel of the vehicle;
performing a correlation procedure correlating the one or more sets of sensor measurement data with stored reference sensor measurement data; and
determining a relative position of the vehicle against stored location data associated with the stored reference sensor measurement data in dependence on the correlation procedure.

10. The positioning method according to claim 9, comprising obtaining sets of sensor measurement data representative of the environment at a plurality of different heights.

11. The positioning method according to claim 9, comprising obtaining sets of sensor measurement data representative of the environment on both sides of the vehicle.

12. The positioning method according to claim 9, comprising obtaining a plurality of sets of sensor measurement data representative of the environment on both sides of the vehicle and at a plurality of different heights.

13. The positioning method according to claim 9, wherein the reference sensor measurement data comprises measurement data previously obtained using at least one sensor of substantially the same type as the at least one sensor located on or in the vehicle.

14. The positioning method of claim 9, wherein the correlation procedure comprises determining a maximum value of a correlation function, said maximum value being representative of a longitudinal shift between the one or more sets of sensor measurement data and the reference sensor measurement data.

15. The positioning method of claim 9, comprising determining a relative amplitude of the correlated one or more sets of sensor measurement data and the reference sensor measurement data, said relative amplitude being representative of a lateral offset.

16. The positioning method of claim 11, comprising determining a relative amplitude of the correlated one or more sets of sensor measurement data and the reference sensor measurement data on both sides of the vehicle, said relative amplitude being representative of a lateral offset.

17. A non-transitory computer readable medium comprising computer readable instructions that, when executed by a processing resource of a positioning system, causes the positioning system to perform a method according to claim 9.

18. A system for maintaining reference sensor measurement data, comprising a data store for storing reference sensor measurement data and a processing resource configured to:
receive one or more sets of sensor measurement data from at least one sensor located on or in a vehicle, each set of sensor measurement data being indicative of the distance of objects from the sensor, and each set of sensor measurement data comprising data obtained from a range of positions in a time or distance window along the direction of travel of the vehicle;
determine whether the received one or more sets of sensor measurement data differ from the stored reference sensor measurement data, said difference being indicative of a temporary or permanent change in the environment; and
amend the stored reference sensor measurement data using the received one or more sets of sensor measurement data if such a difference is determined.

19. The system of claim 18, wherein the processing resource is arranged to receive sets of sensor measurement data from a plurality of vehicles, and to amend the stored reference sensor measurement data in dependence on the sets of sensor measurement data received from the plurality of vehicles.

20. A method for maintaining reference sensor measurement data, comprising:
receiving one or more sets of sensor measurement data from at least one sensor located on or in a vehicle, each set of sensor measurement data being indicative of the distance of objects from the sensor, and each set of sensor measurement data comprising data obtained from a range of positions in a time or distance window along the direction of travel of the vehicle;
determining whether the received one or more sets of sensor measurement data differ from stored reference sensor measurement data, said difference being indicative of a temporary or permanent change in the environment; and
amending the stored reference sensor measurement data using the received one or more sets of sensor measurement data if such a difference is determined.

21. The method of claim 20, comprising receiving sets of sensor measurement data from a plurality of vehicles, and amending the stored reference sensor measurement data in dependence on the sets of sensor measurement data received from the plurality of vehicles.

22. A non-transitory computer readable medium comprising computer readable instructions that, when executed by a processing resource of a system, causes the system to perform a method according to claim 20.
